(19) United States
(12) Patent Application Publication
(10) Pub. No.: US 2013/0328931 A1
(43) Pub. Date: Dec. 12, 2013

(54) System and Method for Mobile Identification of Real Property by Geospatial Analysis

(71) Applicants: Guy Wolcott, Bethesda, MD (US); Louis Mintzer, JR., Occoquan, VA (US); Tariq Seifuddin, Washington, DC (US)

(72) Inventors: Guy Wolcott, Bethesda, MD (US); Louis Mintzer, JR., Occoquan, VA (US); Tariq Seifuddin, Washington, DC (US)

(21) Appl. No.: 13/912,775

(22) Filed: Jun. 7, 2013

Related U.S. Application Data
(60) Provisional application No. 61/656,724, filed on Jun. 7, 2012.

(51) Int. Cl. G06T 11/60

(52) U.S. Cl. CPC G06T 11/60
USPC 345/633

(57) ABSTRACT

A system and method of identifying real property based on real time sensor collected geospatial data regarding the location, orientation and field of view of a camera enabled mobile computing device by a mobile device and collecting and returning information related to the identified real property. A mobile device user takes a picture of a property (i.e. home, building, structure etc.) at which time the client software captures the device's location and orientation-related sensor data before, during and after the picture is taken, and sends this data and the picture to the servers. The servers examine this data and use it to construct a database query of potential property matches, and the criteria by which those potential matches will be scored. The servers then score each candidate property against the criteria, and return the best match or matches to the client device, including additional information about each property. The client renders this information for the user, records passive or active user feedback about the accuracy of the match and information, and sends that feedback back to the server.

### CROSS-REFERENCE TO RELATED APPLICATION

This application claims the benefit under 35 U.S.C. §1191 of U.S. Provisional Patent Application Ser. No. 61/656,724 filed Jun. 7, 2012, which is incorporated herein by reference.

### BACKGROUND OF THE INVENTION

1. Field of the Invention

The present invention relates generally mobile augmented reality systems and more specifically to devices and methods for identifying real property based on real time sensor collected geospatial information and analysis.

2. Description of the Background

Modern mobile computing devices such as smartphones and tablet can be location aware based on real time data collection from sensors such as cameras, accelerometers and magnetometers as well as the Global Positioning or GPS system. When coupled with a wireless Internet connection such devices can collect and display data on their surroundings in real time. Such systems are referred to as augmented reality or AR systems. FIG. 1 is an exemplary AR system in which an icon representing a geographic location is superimposed over the camera viewport and sometimes annotated with information about the locations. FIG. 2 is an exemplary geographic position-based information access system in which icons representing geographic locations are shown on a map in their approximate location, often in relation to the present location of the mobile device.

Such systems are of use to individuals interested in purchasing real property who often explore an area of interest in an effort to identify available properties. Upon finding such a property, interested individuals naturally desire additional information relating to the offered property as well as on surrounding properties and the area as a whole. The above identified systems are capable of providing basic, generalized information on the area but are not accurate enough to be able to be capable of identifying individual properties. Consequently, individuals interested in collecting information on a specific property must manually identify the property of interest by a unique identifier, typically a street address, and to search for information on or related to the property of interest based on that identifier. When available, such information is maintained in disparate private and public databases requiring significant effort on the part of the interested potential purchaser to collect and collate.

### SUMMARY OF THE INVENTION

It is, therefore, an object of the present invention to provide a system and method of identifying individual properties based on location specific information collected from a smartphone or similar mobile device.

It is another object of the present invention to identify a unique identifier for a subject property and to collect and collate information on or related to the identified property from multiple public and private data sources.

According to the present invention, the above-described and other objects are accomplished, by a system and method of identifying real property (i.e. homes, buildings, etc.) using a sensor-enabled mobile device and server-based algorithms and data.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is an example of an augmented reality system deployed on a mobile device.

FIG. 2 is an example of a map-based geographic position-based information system deployed on a mobile device.

FIG. 3 is a schematic diagram of a system according to the present invention.

FIG. 4a is a schematic diagram of the method of the present invention.

FIG. 4b is a schematic diagram of the data processing subroutine carried our on the central data server(s) of the present invention.

FIG. 5 is a mobile device capturing an image of a subject property according to the present invention.

FIG. 6 is an exemplary display of the property information identified and transmitted to the user of a system according to the present invention.

FIG. 7 is a diagram of the nearest property points, the starting point and the starting heading used by the property matching algorithm.

FIG. 8 is a diagram of the arc used by the property matching algorithm to select match candidates from the universe of properties.

FIG. 9 is a diagram of three groups of properties organized into blocks based on their addresses and physical proximity.

FIG. 10 is a diagram of ten property polygons and the arc used by the property matching algorithm.

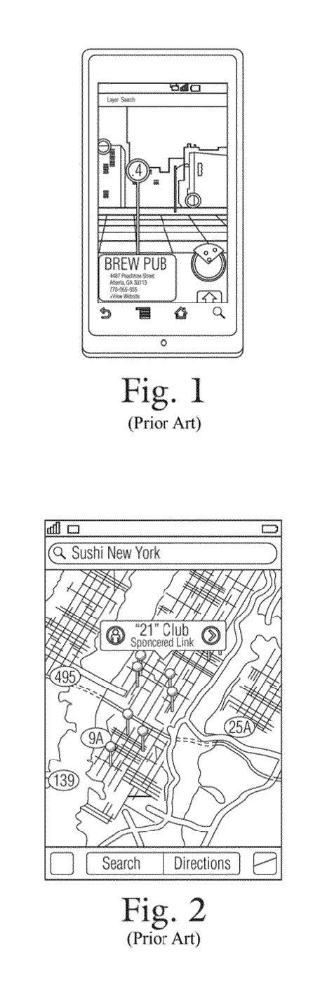

### DETAILED DESCRIPTION OF THE PREFERRED EMBODIMENT

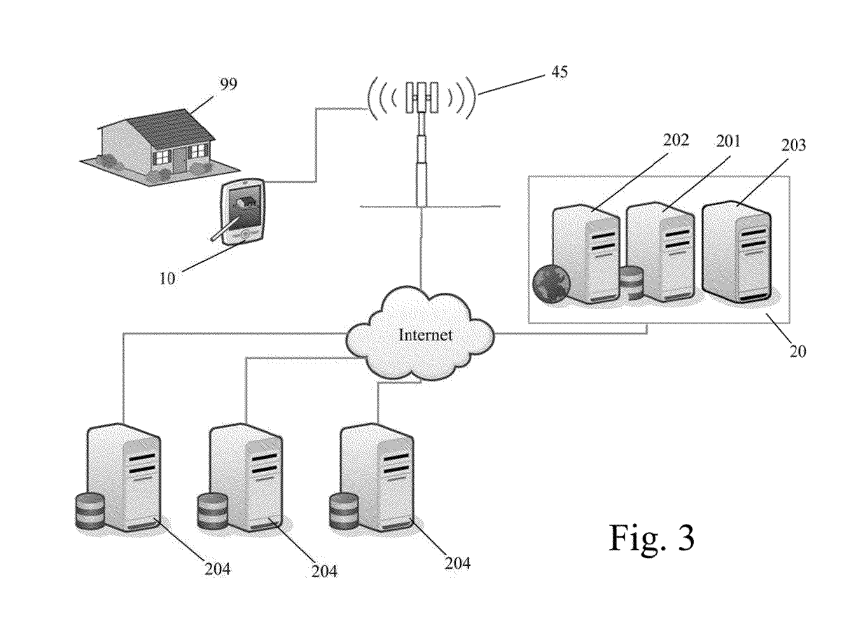

The present invention is a system and method of identifying individual real properties based on real time sensor collected geospatial data regarding the location, orientation and field of view of a camera enabled mobile computing device, and for collecting and presenting to a user detailed information regarding and relating to the identified property. With reference to FIG. 3, the system preferably employs a wirelessly connected mobile computing device 10 such as a smartphone or tablet to collect and transmit to a central data service provider 20 sensed location and device orientation information necessary to identify a property and to display the information collected and transmitted to the mobile device 10 by the central data system 20.

The mobile computing device 10 of a preferred embodiment of the invention may be a smartphone or similar handheld computer. The iPhone offered by Apple, Inc. of Cupertino, Calif. is but one of many such mobile computing devices which are known to those skilled in the art. The mobile computing device 10 includes the following:
a. a digital processor
b. a display or video-out capability
c. a camera
d. location identification services, such as those enabled by a Global Positioning System (GPS), WiFi or cellular antenna triangulation
e. one or more, but preferably all, of the following sensors:
   i. a magnetometer
   ii. a three-dimensional accelerometer
   iii. a gyroscope
f. a wireless connection 144 to a data network 146 such as the Internet.

A system according to the present invention further includes the wireless data network 45 such as 3G, 4G or WiFi covering the area of use and one or more Internet-accessible servers to store relevant property data and to receive and process sensor data from the mobile computing device 10 as will be described. The following software components are also required for the preferred embodiment:

Client Software
a. an application, program or operating system software module executed on the mobile computing device 10 to access the host mobile computing device's camera and other sensors, and to provide a graphical interface for the user.

Server Software
a. database management software executed on one or more database servers 201,
b. web server 202 or other client-server interaction controller executed on one or more web/communications servers, and
c. a computing environment such as an application server 203 for executing algorithm computer code as will be described. The server software may be executed on a single machine or preferably distributed between multiple interconnected computer servers.

Property Data
a. a reference database describing the universe of possible real property match results, containing:
   i. Human-readable names for the property (i.e. an address, building name, etc.),
   ii. Additional details about the property such a for example, property descriptions (number of rooms, size etc.), property tax information, owner information, sales information, etc.,
   iii. Latitude and longitude for each property. Additionally, or alternately, the latitude/longitude can be converted from a geospatial coordinate system to a 2D, flat or geometric coordinate system for faster matching,
   iv. Optionally, a lot boundary polygon for each property and/or a building outline polygon for the primary structure of each property. Such polygons can be geospatial, or converted to a geometric system for faster matching,
   v. Optionally, meta data about organized groups of properties (i.e. city or neighborhood blocks),
   vi. Optionally, data about roads and other geographic reference points, and each property's position relative to such reference points, and
   vii. Optionally, reference photos for some or all properties.

Property data may be stored in a single database location 203 or may be distributed between multiple public and private database locations 203, 204.

In use, the system of the present method operated according to the following steps. It should be noted that not all steps are required in all embodiments of the present invention nor are the steps required to be performed in a particular sequence.

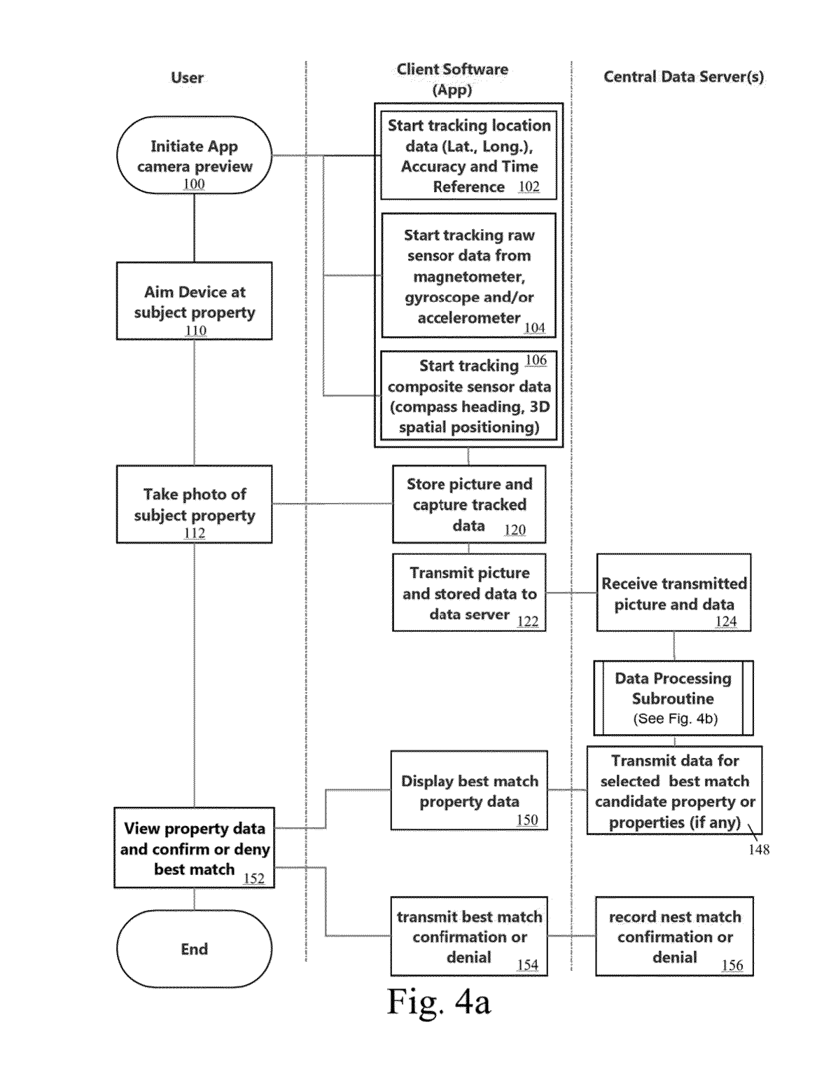

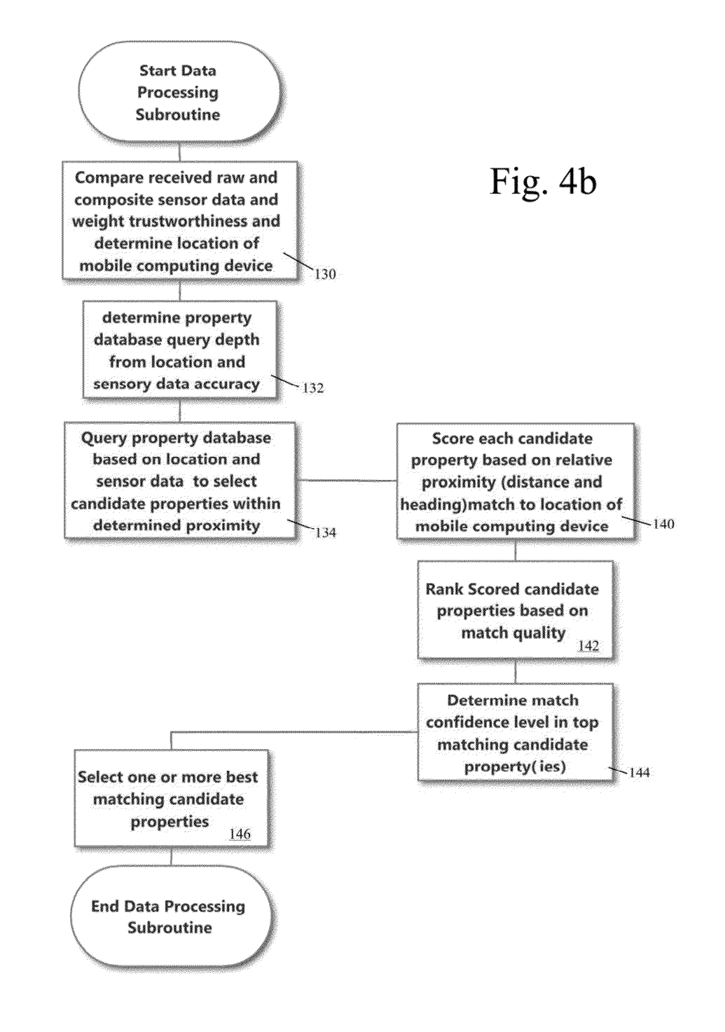

With reference to FIG. 4a, a user initiates a video preview 100 of the mobile device's camera view, at which time:
a. at 102 the client software starts to track location data from the client operating system or GPS subsystem, including latitude, longitude, accuracy and timestamps;
b. at 104 the client software starts to track raw data from the device's sensors, including the magnetometer, accelerometer and/or gyroscope; and
c. at 106 the client software starts to track composite sensor data available from the operating system, including a compass heading and a quaternion representing the device's movement in 3D space.

One skilled in the art will understand that the accuracy of the location data obtained from the GPS system/subsystem may be determined by one of several known methods that resolve to identify a statistically significant distance dimension representative of the accuracy of the location data. Accuracy with respect to location data refers to the closeness of the determined location to the true location of the device. GPS location data accuracy for consumer equipment such as that provided in many handheld electronic devices is obtained by calculating the Circular Error Probability (CEP). CEP refers to the radius of the smallest circle centered on the unknown true position of the device that encompasses 50% of the measured/calculated positions. An alternate measure is referred to as R95 and refers to the radius of the smallest circle centered on the unknown true position of the device that encompasses 95% of the measured/calculated positions. A third common method of determining the accuracy of the location data is 2DRMS (two times the Distance Root Mean Squared). 2DRMS is the 95-98% probability that the true position will be within the stated 2 dimensional accuracy of the determined position. The probability varies between 95-98% because of differences in the standard deviation between latitude and longitude. Each method returns a distance figure representative of the accuracy of the location. The location data accuracy may be determined by the client software or the server software, or both.

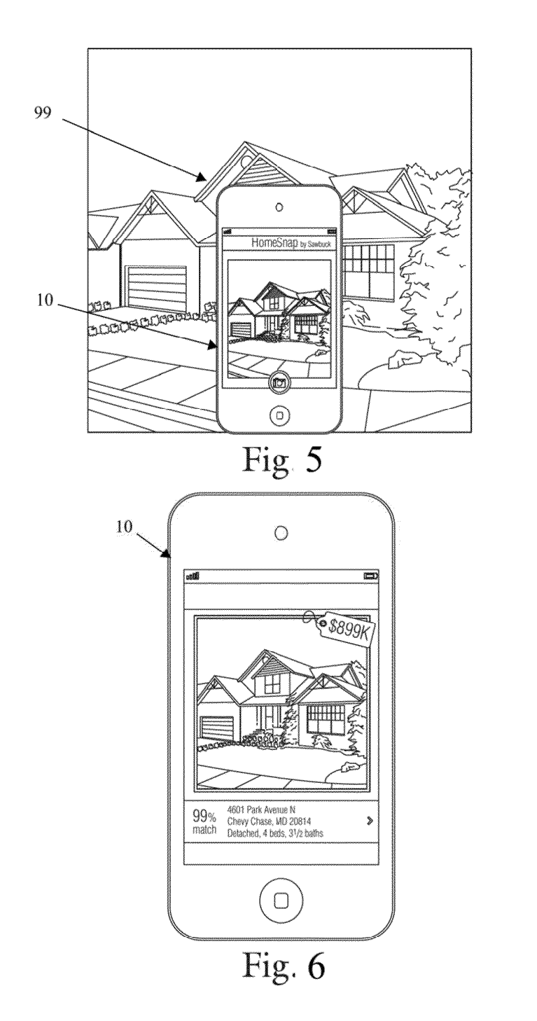

With continued reference to FIG. 4a and additional reference to FIG. 5, at 110 the user aims the device's camera at the property of interest 99 using the video preview.

The user takes a picture of the property using the client software at 112, at which time:
d. at 120 the client software stores the picture, resizing it for quick transmittal to the server, if necessary; and
e. the client software captures the final state of the data described in [0025] above at the moment the picture is taken

The client software sends the picture and above-described sensor and location data to central data server or servers at 122.

With reference to FIG. 4b, the central data servers processes the data received from the client device at 124:
f. At 130, based on an algorithm, the data server(s) compares the received raw sensor data to the received composite sensor data and decide whether to trust one, the other, or a weighted blend of the two; and
g. At 132, based on an algorithm, the data server(s) look at the location and sensor accuracy data, plus the variance in the raw sensor data from just before the picture is taken, to determine how broadly (or narrowly) to query the property data in the database.
h. At 134, the server software queries the database and retrieves data on all potential matching properties and appropriate metadata (i.e. blocks, roads, lot boundaries, pictures, etc.).

The server software selects the property that is the best match:
i. At 140, based on an algorithm, the data server(s) compare the processed location and sensor data (from [0028] above) to each candidate property retrieved from the database;
j. At 142, based on an algorithm, the data server ranks the candidate properties by match quality; and
k. At 144, again, based on an algorithm, determines a confidence level in its top-quality match.

The server selects the best match property or properties at 146 and sends the property data for the selected properties back to mobile computing device at 148. As determined by the algorithm, the server may return:
i. a single property as the best match;
ii. a list of possible matches;
iii. a combination of both: a single primary match, but a list of possible secondary matches; or
iv. no matches.

With reference to FIG. 6, the client device 10 displays property data for user at 150. If a single match exists, the client device will display data about that one property, often in combination with the picture taken by the user as depicted at 112 (see FIG. 5). If multiple matches exist, the client device will present the possible matches to the user (i.e. on a map or list) and the user can then select the best match for themselves.

Once the match is accepted by the user at 152, the client device sends confirmation of the match back to the server at 154. Server records the match at 156 for future reference by the user, and improvements to the accuracy of the matching algorithm. As more and more matching results are confirmed (or denied) by users and stored in the database, accuracy of property matching can be improved because (1) the algorithm can better calibrate its evaluation of the accuracy and trustworthiness of the location and sensor data received from the client device, and (2) the algorithm can better calibrate its property match scoring system, including the weights given to each component part of the score.

An important feature of this invention is the ability of the system to select the best match from the associated property database using location and sensor data from the client device. This feature is enabled by employing a combination of the following property identification methods:

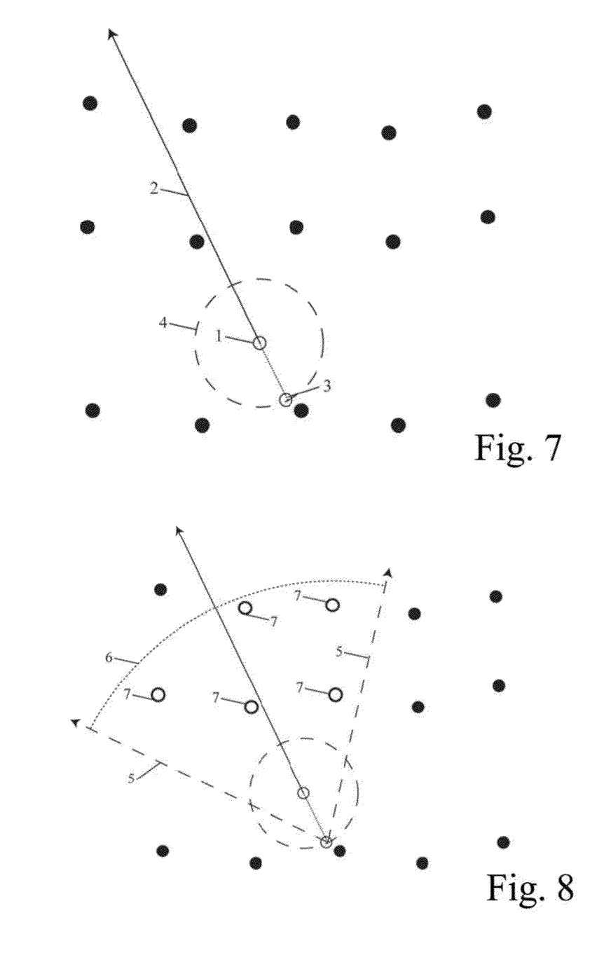

With reference to FIGS. 7 and 8, a method of identifying points inside an arc is disclosed. First, based on the location data (and accompanying location accuracy data) sent to the server from the mobile device, the server algorithm selects a starting point 1 (latitude/longitude) for its search. The starting point 1 represents the server's determination of the actual location of the mobile device. Based on the raw and composite sensor data (and accompanying accuracy data) sent to the server from the mobile device, the server algorithm then selects a starting heading or azimuth 2. The starting azimuth 2 represents the server's determination of the direction in which the mobile device's camera's field of view is pointing. To compensate for inaccuracy/uncertainty in the location, represented by dashed circle 4, the algorithm moves the starting point backwards along the azimuth 2 to reach a revised starting point 3. The radius of circle 4 is preferably equal to the GPS location data accuracy as determined by CEP, D2RMS or other method as described above.

The algorithm then selects a buffer of X degrees on either side of the azimuth 2 resulting in an arc 5 of 2× degrees centered on the starting azimuth. The buffer angle can be selected from a default value or modified based on, for example, accuracy or value of the sensed device orientation data. Where the system has a higher degree of confidence in the device orientation data, a narrower buffer angle may be selected. Conversely, where confidence in the device orientation data is low, a wider buffer angle may be selected. Additionally, location-specific data, such as property density in the area (i.e., urban, suburban, rural, etc.) may also inform the selection of buffer angle. The server next queries the database for properties within the prescribed arc 5, and within a prescribed radius 6 from the revised starting point 3. The radius 6 has a default distance, but can be modified, again based on the density of properties in the immediate area. Each candidate property 7 returned from the database is scored based on (1) its distance from the original starting point 1 and (2) the difference in degrees (or radians) between the starting azimuth 2 and the heading 8 created by connecting the revised starting point and the property (using its latitude/longitude). The algorithm weights these scores based upon its confidence in the various sensor data. When confidence in the device orientation data is high, degree difference will be weighted more heavily, relative to linear distance in calculating a composite match score; conversely, when confidence in the device orientation data is low, degree difference will be weighted less heavily, relative to linear distance.

In addition to the points-inside-an-arc method, a reverse geocoding process can be used to supplement other methods in order to improve property match accuracy when street address data is part of the property data set. Based on the location data from the mobile device, the server or mobile computing device software attempts to determine the name of the street the user is standing nearest at the time they take the picture. This may be done using an internal database or through external “reverse geocoding” services from outside vendors. Where a street name is identified, properties identified as a best match through other methods are given an improved score if they are located on the same street as the user.

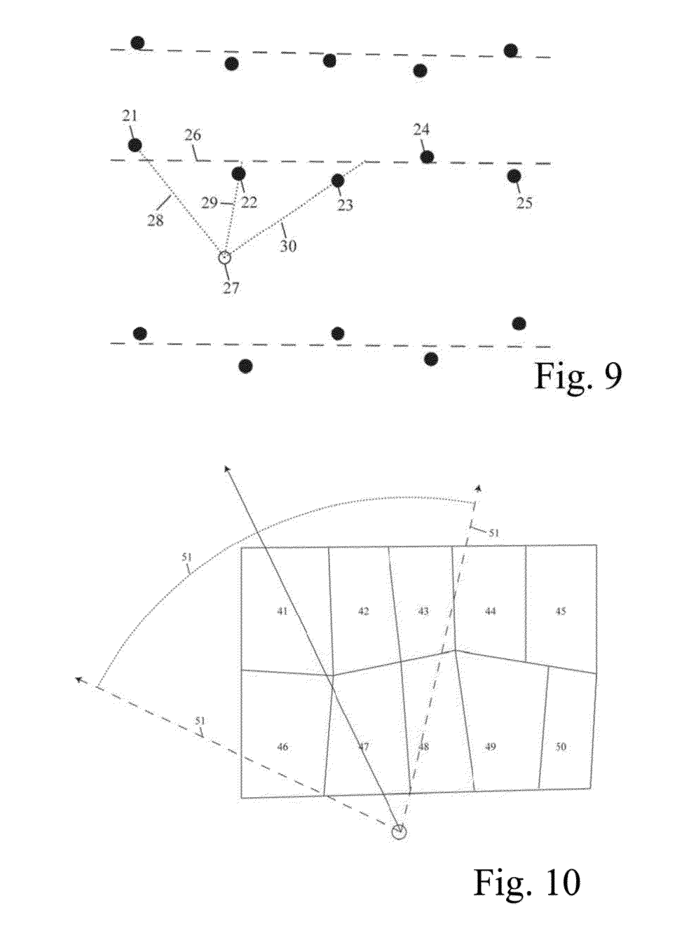

Similarly, with reference to FIG. 9, a property groups (i.e., blocks) method can be used in conjunction with other property identification methods to improve the accuracy of the results. This method takes advantage of the relative uniformity of spacing and position of homes built in modern residential subdivisions. By this method, property location data is grouped into blocks, based upon either street address (i.e. odd street numbers between X and Y on the same street) or physical proximity such as, for example, properties 21, 22, 23, 24 and 25 each have addresses that indicates that they are on the same neighborhood block. The locations (latitude/longitude) of the properties in that block are normalized or averaged into a single vector or line segment 26 that is stored in the database. Properties identified as a best match through other methods are tested with the following method to better identify a single best match:
a. A line 28, 29, 30 is drawn from each candidate property 21, 22, 23 to the starting point 27 (i.e., the actual or corrected location of the mobile device as in the points-inside-an-arc method described above) is compared to the vector for that property's block stored in the database
b. The angle formed by the intersection of each line 28, 29, 30 with line segment 26 is determined and compared. The line that intersects closest to a 90 degree angle is scored highest and the match score for that property is increased. In the exemplary case of FIG. 8, the angle between segment 26 and line 29 is closest to 90 degrees such that this property would be a more favored match. The property match score is improved the closer this angle is to 90 degrees.

This method is especially useful when the location data is deemed accurate but other sensor data is less accurate

With reference to FIG. 10, a method of utilizing lot boundaries to increase the accuracy of the property match is disclosed. When available, using lot boundary polygons rather than individual latitude/longitude points for each property allows more accurate property matching.

By this method, the same location and sensor data is collected as with the points-inside-an-arc method, but instead of querying the database for points in an arc, the algorithm queries for polygons that intersect this arc 51. The algorithm then scores each candidate property returned from the database based on:
a. the distance from the (original) starting point to the property's polygon; and
b. the difference in degrees (or radians) between the starting azimuth and the heading created by connecting the revised starting point 3 and the property's polygon, using the closest point on the polygon to the starting azimuth.

The algorithm then examines the best scored properties as above. This method improves the score of properties with polygons that can connect to the starting point with a line that does not pass through another property's polygon and reduces the score of properties with polygons that can only connect to the starting point with a line that does pass through another property's polygon. Lot boundary polygons also allow for even more accurate property groups (blocks) to be stored in the database (as above). In FIG. 10, each property 41-50 is represented by a polygon rather than a single point. The algorithm would evaluate each property whose polygon intersected the defined arc 51, in this case properties 41-44 and 46-48, but not 45, 49 or 50.

In addition to lot boundary polygons, primary structure polygons which geo-locate the primary structure on each property allow even more accurate property matching. Users most often take a picture of a structure, not the land on which it sits, such that polygons representing the footprint of the primary structure (i.e. home, building, etc.) can be used in similar fashion to the lot boundary polygon method above. When available, making street polylines available to the algorithm also allows for more accurate property matching. When location data is deemed inaccurate, or less accurate than desired, the algorithm can “snap” the starting point to the closest point on the nearest street polyline to provide more accurate results when combined with other methods.

When reference photos are available, supplementing other property matching methods with image recognition allows for more accurate property matching. Assuming a large property universe, image recognition, or “photo matching,” is a poor choice as a primary property matching method. However, it is useful instead as a “tiebreaker,” applied after other methods have produced a very small number of best matches, to select the single best match. Many different image recognition technologies exist and could be employed in this method. Image recognition technology is prior art and not itself part of the invention.

Novel characteristics of the invention not present in other property or object identification systems on mobile devices are as follows. The following list should be taken as illustrative rather than limiting.
1. The tying of hardware, software and data together in the method outlined above into a single, unified system.
2. The tying together of mobile device location and sensor data capture to user picture taking
3. The ability to correct for location and sensor data errors or inaccuracy by processing property matches asynchronously.
4. The use of location and sensor data from the period just prior to the user's picture taking to judge sensor data accuracy and reliability.
5. The use of real-time feedback to the user on the mobile device (during photo preview) to produce optimal location and sensor data.
6. The use of polygons in evaluating property matches, not just latitude/longitude points.
7. The use of property groups (i.e. blocks) to correct for sensor inaccuracies and improve matching accuracy.
8. The use of image recognition as a “tiebreaker” among a small number of the best matched properties identified by other matching methods.
9. The tying together of data about the identified property to the user's original photo.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A computer implemented method of selecting from a database containing the location of a plurality of real properties a best match real property based on at least one of location data and sensor data received from a mobile computing device having a camera and a fixed position, comprising the steps of
receiving from said mobile computing device via a communications network at least one of said location data and said sensor data,
determining a location of said fixed position of said mobile computing device based on at least one of said location data and said sensor data and further determining a level of accuracy of said location determination, said level of accuracy expressed in terms of a distance,
determining a heading in which said camera is pointing based on at least one of said location data and said sensor data,
selecting a starting point by moving backward along said heading a distance equal to said level of accuracy,
designating an area comprising a circular sector centered at said starting point, having a radius and a central angle, said central angle centered on said heading,
selecting as candidate properties, from said property database, all properties within said area,
calculating an angle between said heading and a line drawn between said starting point and each said candidate property,
assigning a first score to each candidate property based on said calculated angle, said first score being at least one component of a composite score of each candidate property, and
selecting as a best match the candidate property having the best composite score.

2. The method of claim 1, wherein said step of determining a location of said fixed position further comprises determining a latitude and a longitude of said fixed position.

3. The method of claim 1, wherein said mobile computing device includes a GPS receiver and wherein said location data is determined by said GPS receiver.

4. The method of claim 1, wherein said step of determining a location of said fixed position further comprises triangulation of said fixed position relative to a plurality of transceivers of said a communications network.

5. The method of claim 1, wherein said step of designating an area further comprises varying said central angle inversely proportionally to a confidence level in said determined heading, wherein a greater confidence in said determined heading correlates to a smaller central angle.

6. The method of claim 1, wherein said step of designating an area further comprises varying said central angle inversely proportionally to a property density in the vicinity of said location of said fixed position wherein a greater property density correlates to a smaller central angle.

7. The method of claim 1, wherein said step of designating an area further comprises varying said radius is inversely proportionally to a property density in the vicinity of said location of said fixed position wherein a greater property density correlates to a smaller radius.

8. The method of claim 1, wherein said step of determining a level of accuracy of said location determination further comprises calculating said distance according to one selected from the group consisting of Circular Error Probability, R95 and 2DRMS.

9. The method of claim 1, wherein said step of receiving from said mobile computing device further comprises receiving at least one of a magnetometer reading, an accelerometer reading, a gyroscope reading and a camera image.

10. The method of claim 1, further comprising the steps of
calculating a distance between each said candidate property and said fixed position of said mobile computing device, and
assigning a second score to each candidate property based on said calculated distance, said second score being at least one component of said composite score.

11. The method of claim 10, wherein said first score is weighted relative to and combined with said second score to obtain said composite score, said first score being weighted relatively higher when a confidence level in the accuracy of said heading is higher.

12. The method of claim 1, further comprising the steps of identifying a road on which said fixed position is located, and increasing the composite score of each candidate property having an address on said road.

13. The method of claim 1, further comprising the steps of
normalizing a position of a plurality of proximally located properties into a block line segment though said plurality of proximally located candidate properties and storing block line segment in said database,
if at least one of said candidate properties is among said proximally located properties, drawing a vector line between said starting point and each said candidate property,
determining an angle formed between each said vector line and said block line segment, and
increasing the composite score of each candidate property proportionally to the difference between said angle and 90 degrees.

14. The method of claim 1, wherein said location of each of said plurality of real properties contained in said database is a polygon representing the boundary of each said real property,
wherein said step of selecting candidate properties from said property database comprises selecting all properties whose polygon intersects said circular sector, and
wherein said step of calculating an angle between said heading and a line drawn between said starting point and each said candidate property comprises calculating an angle between said heading and a line drawn between said starting point and a point on said polygon closest to said starting point.

15. The method of claim 14, further comprising the steps of
calculating a distance between said fixed position of said mobile computing device and the closest point on said polygon of each said candidate property, and
assigning a second score to each candidate property based on said calculated distance, said second score being at least one component of said composite score.

16. The method of claim 1, wherein the location of said plurality of real properties contained in said database is point defined by a latitude and a longitude.

17. The method of claim 1, wherein the location of said plurality of real properties contained in said database is a latitude and a longitude of a structure located on each said real property.

18. The method of claim 1, further comprising the steps of
receiving from said mobile computing device an image captured by said camera,
comparing said captured image with a reference image of each candidate property stored in said property database, and
assigning a second score to each candidate property based on a similarity between said captured image and said reference image, said second score being at least one component of said composite score.

19. A method of providing data relating to a piece of real property sensed by a mobile computing device having a digital processor, a video display, a camera, a GPS location identification system, a wireless connection to a data network, and at least one of a magnetometer, a three-dimensional accelerometer and a gyroscope, said method the steps of:
providing a central data server in communication with said mobile computing device via said data network, said central data server having a database of real property information,
providing an instruction set for execution by said digital processor of said mobile computing device,
tracking, according to said executed instruction set, location data of said mobile computing device from said GPS location identification system, movement data from said magnetometer, accelerometer and gyroscope, and orientation data,
simultaneously with the taking of an image of a property of interest by said camera, capturing a final state of said location data, movement data and orientation data;
transmitting, according to said executed instruction set, said image and said location data, movement data and orientation data to said central data server via sad wireless connection to said data network,
querying said database by said central data server and retrieving data relating to at least one candidate properties based having a location within a predetermined proximity to said location data of said mobile computing device,
ranking, by said central data server, the one or more candidate properties according to order in which said candidate property location matches the location data of said mobile computing device.
returning to said mobile computing device via said a wireless connection to a data network said retrieved data on said one or more potential matching properties for which the location information is a best match for display via said video display by set instruction executed by said digital processor.

20. The method of claim 19 further comprising the step of determining by said central data serve, a direction in which said camera was pointed when said image was captured and wherein said predetermined proximity is an area located in said direction in which said camera was pointed relative to said location data of said mobile computing device.

21. A system for identifying data relating to a piece of real property sensed by a mobile computing device having a digital processor, a memory, a video display, a camera, a GPS location identification system, a wireless connection to a data network, and at least one of a magnetometer, a three-dimensional accelerometer and a gyroscope, said system comprising:
a first instruction set for storage in said memory of said mobile computing device which configures the digital processor of said mobile computing device to transmit via said data network at least one of data identifying a location of said mobile computing device and data collected from one or more of said GPS system, camera, magnetometer, accelerometer and gyroscope;
a computer server comprising at least one computer processor and at least one memory having a second instruction set which configures the at least one computer processor to:
receive said data transmitted from mobile computing device;
identify from said received data a location of said mobile computing device and a heading in which said camera of said mobile computing device is pointed;
access real property data from a database wherein said real property data includes a location of a plurality of defined real properties;
select from said database as candidate properties all defined real properties within a predefined proximity to said location of said mobile computing device,
score each candidate property based on an angle formed between said heading in which said camera of said mobile computing device is pointed and a line drawn between said location of said mobile computing device and said each candidate property;
select as a best match property at least one candidate property having the best score; and
transmit via said data network to said mobile computing device for display on said video display said real property data from said database relating to said best match.

22. The system of claim 21 wherein when said the digital processor of said mobile computing device is configured to transmit both data identifying a location of said mobile computing device and data collected from one or more of said GPS system, camera, magnetometer, accelerometer and gyroscope, said second instruction set configures the at least one computer processor of said server to further
determine an accuracy of said of data identifying a location of said mobile computing device and of said data collected from one or more of said GPS system, camera, magnetometer, accelerometer and gyroscope; and
modify said predefined proximity based on the determined accuracy of said received data.

23. The system of claim 21 wherein said predefined proximity is an area in the shape of a sector of a circle centered at said identified location of said mobile computing device and having a predefined buffer angle centered on said identified heading in which said camera of said mobile computing device is pointed.

24. The system of claim 23 wherein said second instruction set configures the at least one computer processor of said server to further
determine an accuracy of said of data identifying a location of said mobile computing device and of said data collected from one or more of said GPS system, camera, magnetometer, accelerometer and gyroscope; and
modify said predefined buffer angle based on the determined accuracy of said received data.

25. The system of claim 21 wherein said first instruction set further configures the digital processor of said mobile computing device to transmit an accuracy of said transmitted data.
